(19) United States
(12) Patent Application Publication
(10) Pub. No.: US 2019/0213790 A1
(43) Pub. Date: Jul. 11, 2019

(54) Method and System for Semantic Labeling of Point Clouds

(71) Applicant: Mitsubishi Electric Research Laboratories, Inc., Cambridge, MA (US)

(72) Inventors: Yuichi Taguchi, Arlington, MA (US); Teng-Yok Lee, Cambridge, MA (US); Srikumar Ramalingam, Cambridge, MA (US); Chen Feng, Cambridge, MA (US)

(21) Appl. No.: 15/867,845

(22) Filed: Jan. 11, 2018

(51) Int. Cl. G06T 19/00; G06F 17/30

(52) U.S. Cl. CPC G06T 19/00; G06F 17/30241; G06K 9/726; G06F 17/3028; G06F 17/3087

(57) ABSTRACT

A system for assigning a semantic label to a three-dimensional (3D) point of a point cloud includes an interface to transmit and receive data via a network, a processor connected to the interface, a memory storing program modules including a communicator and a labeler executable by the processor. In this case, the communicator causes the processor to perform operations including establishing, using the interface, a communication with an external map server storing a map defined in a map coordinate system, determining a location on the map corresponding to the 3D point, and querying the map using the location to obtain an information relevant to the semantic label at the location in the map, wherein the labeler causes the processor to determine the semantic label of the 3D point using the information.

### FIELD OF THE INVENTION

This invention relates generally to computer vision and image processing, and more particularly to semantically labeling three-dimensional (3D) point clouds.

### BACKGROUND OF THE INVENTION

Traditional maps for navigating humans and vehicles are defined on a plane using a two-dimensional (2D) coordinate system. Typically, the plane corresponds to the ground plane and the 2D coordinate system corresponds to the latitude and longitude of the earth. Structures at different altitudes are ignored, or projected to the ground plane and represented using their footprints.

Recently three-dimensional (3D) maps have emerged. 3D maps can include 3D structures and objects, such as buildings, trees, traffic signals, signs, as well as flat or non-flat road surfaces. Such 3D structures and objects can be represented as mesh models or 3D point clouds (sets of 3D points). Some 3D maps, such as Google Street View, include images, either standard or panoramic images, which are viewable from camera viewpoints where the images were captured. 3D maps can provide better visualization and more intuitive navigation to humans, and can provide more information for navigating autonomous vehicles than 2D maps.

3D maps can be generated based on 3D point clouds. To obtain 3D point clouds for large areas, typically 3D sensors such as LIDARs mounted on a vehicle are used. Such a vehicle can employ a global navigation satellite system (GNSS) receiver and an inertial measurement unit (IMU) to determine its trajectory in a GNSS coordinate system. The 3D sensors can be calibrated with respect to the vehicle so that the 3D point clouds can be registered in the GNSS coordinate system. 3D coordinates in the GNSS coordinate system are typically converted to a triplet of (latitude, longitude, altitude) values, and thus each 3D point of a 3D point cloud can have 3D coordinates of (latitude, longitude, altitude).

The obtained 3D point clouds include only 3D geometry information (a set of 3D points). To be useful for the 3D map generation, the 3D point clouds need to be semantically segmented and labeled into, e.g., roads, buildings, trees, etc. This semantic labeling is currently a labor-intensive task and point clouds can be difficult to understand for an untrained eye. In addition, human involvement can raise privacy concerns on sharing the proprietary data.

Accordingly, there is a need for systems and methods suitable for performing semantic labeling to the 3D point clouds, which reduce the labor-intensive task.

### SUMMARY OF THE INVENTION

Some embodiments of the present invention are related to a system and a method, which provide semantic labeling for 3D point clouds.

According to some embodiments of the present invention, a system for assigning a semantic label to a three-dimensional (3D) point of a point cloud, includes an interface to transmit and receive data via a network; a processor connected to the interface; a memory storing program modules including a communicator and a labeler executable by the processor, wherein the communicator causes the processor to perform operations that include establishing, using the interface, a communication with an external map server storing a map defined in a map coordinate system; determining a location on the map corresponding to the 3D point; and querying the map using the location to obtain an information relevant to the semantic label at the location in the map, wherein the labeler causes the processor to determine the semantic label of the 3D point using the information.

According to another embodiment of the present invention, a method for assigning a semantic label to a three-dimensional (3D) point of a point cloud includes steps of establishing, using an interface, a communication with an external map server storing a map defined in a map coordinate system; determining a location on the map corresponding to the 3D point; and querying the map using the location to obtain an information relevant to a semantic label at the location in the map, wherein the semantic label of the 3D point is determined by using the information.

Further, according to an embodiment of the present invention, a non-transitory computer readable medium storing programs including instructions executable by one more processors which cause the one or more processors, in connection with a memory, to perform the instructions include establishing, using an interface, a communication with an external map server storing a map defined in a map coordinate system; determining a location on the map corresponding to the 3D point; and querying the map using the location to obtain an information relevant to the semantic label at the location in the map, wherein the labeler causes the processor to determine the semantic label of the 3D point using the information.

It is another object of some embodiments to provide such a system that makes the labeling task more efficient by providing automatic labeling capabilities or distributing the labor-intensive task via crowdsourcing. Accordingly, the system according to embodiments of the present disclosure can reduce central processing unit usage and power consumption.

It is another object of some embodiments to address some privacy concerns related to sharing the proprietary data including 3D point clouds to be labeled. The labeled 3D point clouds can be used for 3D map generation for human and vehicle navigation.

Some embodiments are based on the realization that 3D coordinates of the points in the point cloud can be used to retrieve information indicative of semantics of the objects at that location. Thus, the semantic labeling can be performed not on the point cloud itself, but on that information retrieved with the help of the point cloud.

For example, there are several 2D or 3D maps that have been already labeled. Thus, if each 3D point of a 3D point cloud can be located in an existing labeled map, then a label for the 3D point can be automatically obtained from the existing labeled map.

Some other embodiments realize that even if the existing maps are not explicitly labeled, the existing maps can include information that is sufficient to label 3D point clouds. For example, some maps, such as Google Street View, include images and allow a method to query a 3D point to retrieve an image that observes the 3D point. In other words, such maps associate a 3D point to an image, or even to a specific pixel of an image. There exist several image classification algorithms that provide a semantic label to an image, and several semantic image segmentation algorithms that provide a semantic label to each pixel of an image. Thus a label for the 3D point can be automatically obtained by labeling the image or each pixel of the image by using those algorithms.

Some other embodiments recognize that such image classification or semantic image segmentation algorithms are sometimes inaccurate for challenging cases (e.g., an image includes several different objects, the 3D point corresponds to a small object). In those cases, humans can provide more reliable labeling results. The embodiments thus convert the image classification or semantic image segmentation tasks into human intelligent tasks (HITs) and distribute HITs to human workers via a crowdsourcing service, such as Amazon Mechanical Turk. Many existing maps are available online and accessible publicly, which makes the crowdsourcing easier.

### BRIEF DESCRIPTION OF THE DRAWINGS

The presently disclosed embodiments will be further explained with reference to the attached drawings. The drawings shown are not necessarily to scale with emphasis instead generally being placed upon illustrating the principles of the presently disclosed embodiments.

FIG. 1 shows a system diagram of a semantic labeling system, according to some embodiments of the present invention;

FIG. 2 shows a flow chart of a semantic labeling method according to some embodiments of the present invention;

FIG. 3 shows an example of an information obtained from a map, according to some embodiments of the present invention; and

FIG. 4 shows another example of an information obtained from a map, according to an embodiment of the present invention.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION OF THE PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims. Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

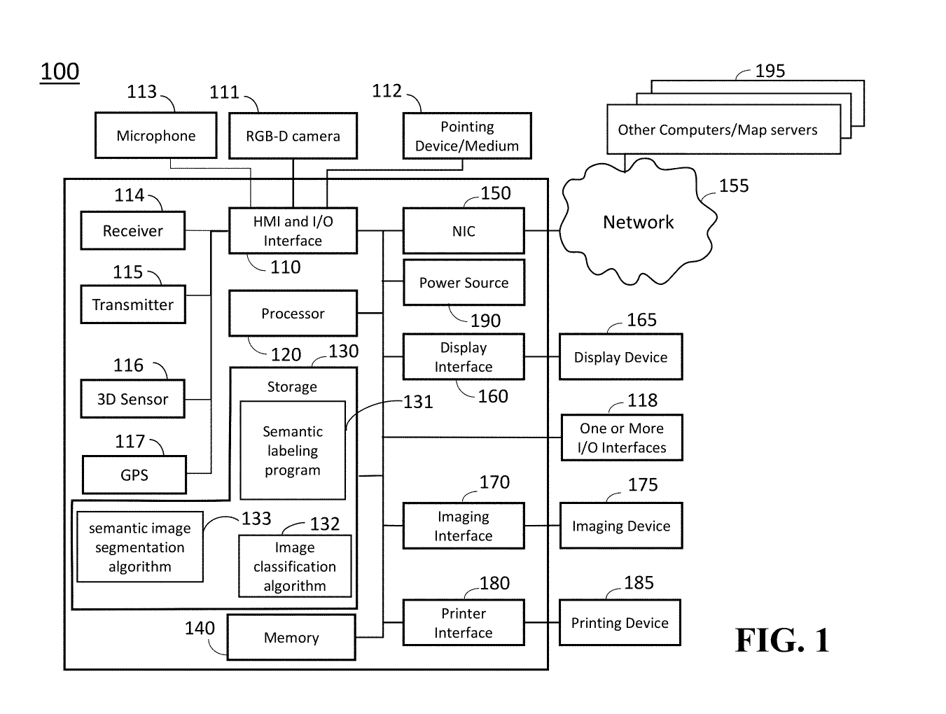

FIG. 1 is a block diagram illustrating a semantic labeling system 100 for labeling 3D point of an object according to embodiments of the present disclosure.

The semantic labeling system 100 can include a human machine interface (HMI) with input/output (I/O) interface 110 connectable with at least one RGB-D camera 111 (depth camera) and a pointing device/medium 112, a microphone 113, a receiver 114, a transmitter 115, a 3D sensor 116, a global positioning system (GPS) 117, one or more I/O interfaces 118, a processor 120, a storage device 130, a memory 140, a network interface controller 150 (NIC) connectable with other computers and Map servers via a network 155 including local area networks and internet network (not shown), a display interface 160 connected to a display device 165, an imaging interface 170 connectable with an imaging device 175, a printer interface 180 connectable with a printing device 185. The HMI with I/O interface 110 may include analog/digital and digital/analog converters. The HMI with I/O interface 110 may include a wireless communication interface that can communicate with other object detection and localization systems, other computers or map servers via wireless internet connections or wireless local area networks. The HMI with I/O interface 110 may include a wire communication interface that can communicate with the other computers and the map servers via the network 155. The semantic labeling system 100 can include a power source 190. The power source 190 may be a battery rechargeable from an external power source (not shown) via the I/O interface 118. Depending upon the application the power source 190 may be optionally located outside of the system 100, and some parts may be pre-integrated in a single part.

The HMI and I/O interface 110 and the I/O interfaces 118 can be adapted to connect to another display device (not shown) including a computer monitor, camera, television, projector, or mobile device, among others.

The semantic labeling system 100 can receive electric text/images, a point cloud including three dimensional (3D) points assigned semantic labels, and documents including speech data using a receiver 114 or the NIC 150 via the network 155. In some cases, an average 3D point with respect to a subset of 3D points is assigned a semantic label. The storage device 130 includes semantic labeling program 131, an image classification algorithm (program module) 132 and a semantic image segmentation algorithm (program module) 133, in which the program modules 131, 132 and 133 can be stored into the storage 130 as program codes. Semantic labeling can be performed by executing the instructions of the programs stored in the storage 130 using the processor 120. Further, the program modules 131, 132 and 133 may be stored to a computer readable recording medium (not shown) so that the processor 120 can perform semantic labeling to 3D points according to the algorithms by loading the program modules from the medium. Further, the pointing device/medium 112 may include modules that read programs stored on a computer readable recording medium.

In order to start acquiring a point cloud data using the sensor 116, instructions may be transmitted to the system 100 using a keyboard (not shown) or a start command displayed on a graphical user interface (GUI) (not shown), the pointing device/medium 112 or via the wireless network or the network 190 connected to other computers 195 enabling crowdsourcing for sematic labeling 3D point clouds. The acquiring of the point cloud may be started in response to receiving an acoustic signal of a user by the microphone 113 using pre-installed conventional speech recognition program stored in the storage 130.

The processor 120 may be a plurality of processors including one or more graphics processing units (GPUs). The storage 130 may include speech recognition algorithms (not shown) that can recognize speech signals obtained via the microphone 113.

Further, the semantic labeling system 100 may be simplified according to the requirements of system designs. For instance, the semantic labeling system 100 may be designed by including the at least one RGB-D camera 111, the interface 110, the processor 120 in associating with the memory 140 and the storage 130 storing the semantic labeling program 131 and image classification 132 and semantic image segmentation algorithms 133, and other combinations of the parts indicated in FIG. 1.

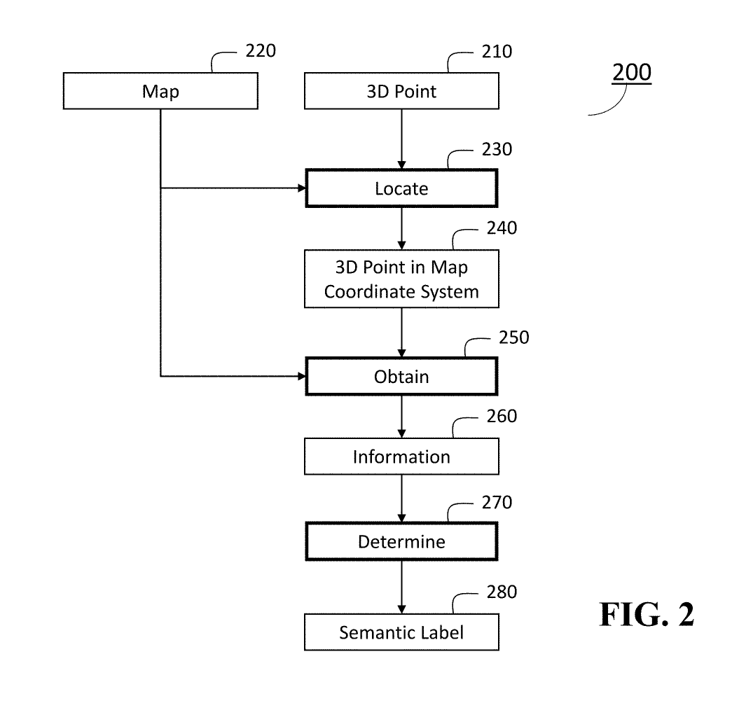

FIG. 2 shows a flow chart illustrating a semantic labeling method 200 performed by the semantic labeling program 131 stored in the storage 130, according to some embodiments of the invention. The semantic labeling method 200 includes a communication step (not shown) to establish a communication with an external map server 195 including other computers via the network 155 using the interface 110 or the NIC 150. The communication step is performed according to a communicator program module (not shown) included in the semantic labeling program 131. The communicator program module may be referred to as a communicator. The input of the method 200 includes a 3D point 210 and a map 220, and the output includes a semantic label 280.

The semantic labeling method 200 takes as an input of a 3D point 210 to be labeled from an unlabeled dataset determined by the system 100. An unlabeled 3D point 210 can be selected by a user or automatically provided by the semantic labeling program 131 according to a predetermined sequence, which is executed by the processor 120 in the semantic labeling system 100. The 3D point 210 can also be acquired by using a 3D sensor 116, such as a Light Detection and Ranging (LIDAR) laser scanner (not shown), a time-of-flight camera (depth camera), and a structured light sensor (not shown). Further, the RGB-D camera 111 can be used for acquiring the 3D point 210. The 3D point 210 can be specified using 3D coordinates, such as a triplet of (x, y, z) values in a sensor coordinate system or a triplet of (latitude, longitude, altitude) values in a GNSS coordinate system. The 3D point 210 can be obtained as a set of 3D points, i.e., a point cloud. In such a case, the method 200 can take each 3D point in the point cloud as the input, or alternatively, the method 200 can apply a predetermined preprocessing to the point cloud to obtain a set of 3D points as the input. In the preprocessing, the point cloud can be geometrically segmented into subsets of 3D points, and each subset of the 3D points represents an object. An average 3D point can be determined for each subset used as the input. A semantic label for all the 3D points in the subset may be represented by a semantic label obtained for the average 3D point. The map 220 can be obtained from the map server 195 via the network 155 according to the communicator program in the semantic labeling program 131, in which the map 220 can be either a 2D map or a 3D map. The map 220 is defined in a map coordinate system (not shown). Typically, the map coordinate system is defined using a pair of (latitude, longitude) as 2D coordinates for 2D maps, and a triplet of (latitude, longitude, altitude) as 3D coordinates for 3D maps.

In step 230, the method 200 first locates the 3D point 210 in the map 220. If the 3D point 210 and the map 220 are defined in the same coordinate system, then in step 240, the 3D point 210 can be directly located in a 3D map using the 3D coordinates, or in a 2D map using the (latitude, longitude) values while ignoring the altitude. If the 3D point 210 and the map 220 are defined in different coordinate systems, a conversion between the different coordinate systems is necessary. The conversion can be given as a fixed set of transformations (e.g., between different GNSS coordinate systems), or can be given by registering data in the different coordinate systems (e.g., when the 3D point is defined in a sensor coordinate system and the map is defined in a GNSS coordinate system, the coordinate systems need to be registered by using, e.g., three corresponding 3D points between the coordinate systems).

If the method 200 cannot locate the 3D point 210 in the map 220, then the labeling process becomes pending and another 3D point to be labeled is provided by the semantic labeling program 131.

The method 200 then obtains, in step 250, information 260 regarding the 3D point 210 from the map 220 using the 3D point located in the map 220. The method 200 finally determines in step 270 a semantic label 280 according to a labeler program (not shown) included in the semantic labeling program 131 for the 3D point 210 using the information 260. The labeler program may be referred to as a labeler. The information 260 can include the semantic label itself if the map is labeled and the map allows a method to extract the semantic label at the 3D point located in the map. Further, the information 260 may not be the semantic label itself, but the information 260 may be relevant to the semantic label. For instance, the information 260 can include a vectorized map data, an aerial image, a satellite image, and an image acquired from a street level, obtained by using the 3D point located in the map as a query, from which the semantic label can be inferred. The semantic label 280 includes low-level object categories such as road, building, tree, traffic signal, sign, and fire hydrant, as well as high-level metadata such as a street address and a name of building, business, and location. It should be also noted that a set of semantic labels can be assigned to a single 3D point.

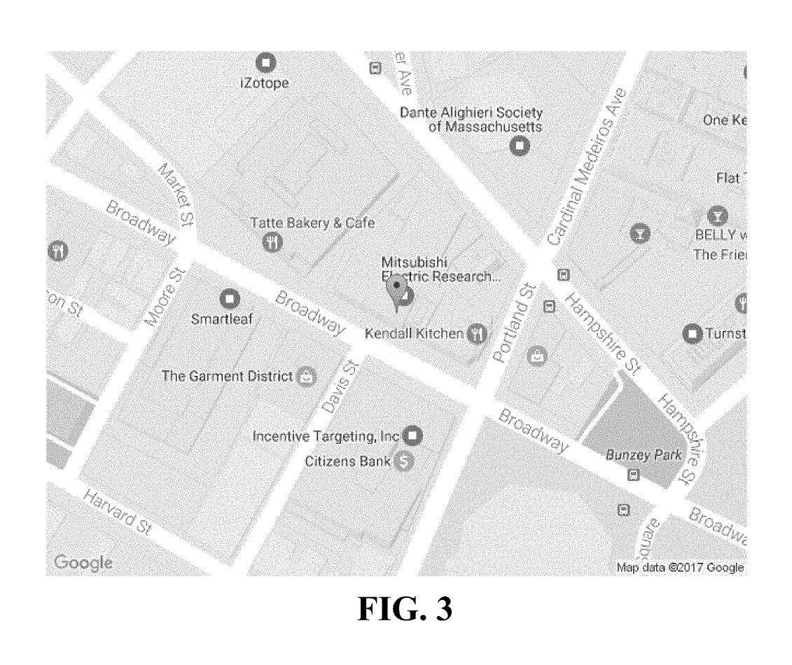

FIG. 3 shows an example of an information obtained from a map, which is a drawing rendered from a vectorized map data obtained by querying the 3D point to Google Maps. The queried point is shown at the center of the drawing with a marker. In this specific example, the vectorized map data is not accessible, but only the drawing rendered from the vectorized map data is available. In such a case, image processing algorithms can be used to analyze the drawing and obtain the semantic label. For example, different object categories are rendered in different colors in this drawing. Thus by looking at the color of the center pixel, or by analyzing the colors in a patch around the center pixel, the semantic label for the 3D point can be automatically obtained (in this example it is a building). Note that if the vectorized map data is accessible, then obtaining the semantic label can be simpler, because the queried 3D point falls within a mesh model of the building for the 3D map, or within a footprint of the building for the 2D map.

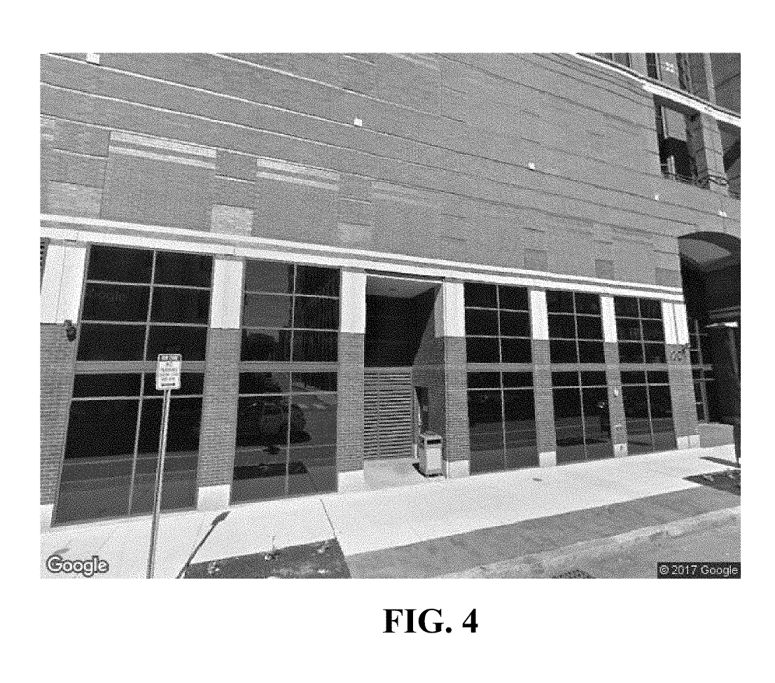

FIG. 4 shows another example of an information obtained from a map, which is an image acquired from a street level obtained by querying the 3D point to Google Street View via the network 155. In this case, the Google Street View is accessed as the map server 195. The queried point is centered in the image. Using an image classification algorithm, this image can be classified as a building. Alternatively, using a semantic image segmentation algorithm, the center pixel of this image can be classified as a building. Thus the semantic label for the 3D point can be automatically obtained by using those algorithms. The same techniques can be applied if an information obtained from a map is an aerial or satellite image. The image classification algorithm 132 and the semantic image segmentation algorithm 133 are stored in the storage 130 as illustrated in FIG. 1. Those algorithms typically use convolutional neural networks (CNNs) and are pretrained using a large set of training data: For the image classification algorithm the training data include pairs of images and their semantic labels (each image is associated to a semantic label), while for the semantic image segmentation algorithm the training data include pairs of images and their pixel-wise semantic label maps (each pixel in each image is associated to a semantic label). Once pretrained, given an input image, the image classification and semantic image segmentation algorithms can respectively estimate a semantic label and a pixel-wise semantic label map.

In some cases, it might be difficult to use the above mentioned automatic procedures to obtain a semantic label. For example, a small object such as a fire hydrant does not appear in the drawing shown in FIG. 3; it can appear in the street-level image shown in FIG. 4 or in an aerial image, but the image classification or semantic image segmentation algorithm might not correctly label such a small object. In those cases, humans can provide more accurate labels. Thus, some embodiments present the information obtained from the map to a human worker, and obtain the semantic label from the human worker.

Crowdsourcing services such as Amazon Mechanical Turk provide an efficient platform to perform such a task with many human workers. In Amazon Mechanical Turk, a task is called human intelligent task (HIT), which is generated by a requester and completed by a human worker. An HIT generated by some embodiments of this invention presents the information obtained from the map to a human worker and asks the human worker what a semantic label corresponding to the information is. The HIT can include a list of semantic labels as possible answers, or can allow the human worker to provide an arbitrary semantic label. Note that many existing maps are available online and accessible publicly. This makes the crowdsourcing easier, and reduces privacy concerns, because only the publicly available map data need to be presented to human workers without presenting the possibly proprietary point cloud data.

The above-described embodiments of the present disclosure can be implemented in any of numerous ways. For example, the embodiments may be implemented using hardware, software or a combination thereof. Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A system for assigning a semantic label to a three-dimensional (3D) point of a point cloud, comprising:
an interface to transmit and receive data via a network;
a processor connected to the interface;
a memory storing program modules including a communicator and a labeler executable by the processor, wherein the communicator causes the processor to perform operations including:
establishing, using the interface, a communication with an external map server storing a map defined in a map coordinate system;
determining a location on the map corresponding to the 3D point; and
querying the map using the location to obtain an information relevant to the semantic label at the location in the map, wherein the labeler causes the processor to determine the semantic label of the 3D point using the information.

2. The system of claim 1, wherein the information includes an image, and wherein the labeler performs an image classification of the image to determine the semantic label of the 3D point.

3. The system of claim 1, wherein the information includes an image, wherein the system further comprises:
a display for rendering the image to a user for performing a semantic labeling of the image, wherein the labeler assigns a label received from the display device as the semantic label of the 3D point.

4. The system of claim 1, wherein the map is a 3D map, the map coordinate system is defined using a triplet of latitude, longitude, and altitude forming 3D coordinates of the 3D map, and the 3D point is located in the map coordinate system using the 3D coordinates.

5. The system of claim 1, wherein the map is a two-dimensional (2D) map, the map coordinate system is defined using a pair of latitude and longitude forming 2D coordinates of the 2D map, and the 3D point is located in the map coordinate system using the 2D coordinates.

6. The system of claim 1, wherein the information includes a drawing rendered from a vectorized map data, and wherein the labeler performs a predetermined image processing algorithm to determine the semantic label of the 3D point.

7. The system of claim 1, wherein an unlabeled 3D point is provided by the labeler.

8. A non-transitory computer readable medium storing programs including instructions executable by one more processors which cause the one or more processors, in connection with a memory, to perform the instructions comprising:
establishing, using an interface, a communication with an external map server storing a map defined in a map coordinate system;
determining a location on the map corresponding to the 3D point; and
querying the map using the location to obtain an information relevant to the semantic label at the location in the map, wherein the labeler causes the processor to determine the semantic label of the 3D point using the information.

9. The non-transitory computer readable medium of claim 8, wherein the information includes an image, and wherein the labeler performs an image classification of the image to determine the semantic label of the 3D point.

10. The non-transitory computer readable medium of claim 8, wherein the information includes an image, wherein the instructions further comprise:
rendering the image to a user for performing a semantic labeling of the image, wherein the labeler assigns a label received from the user as the semantic label of the 3D point.

11. The non-transitory computer readable medium of claim 8, wherein the map is a 3D map, the map coordinate system is defined using a triplet of latitude, longitude, and altitude forming 3D coordinates of the 3D map, and the 3D point is located in the map coordinate system using the 3D coordinates.

12. The non-transitory computer readable medium of claim 8, wherein the map is a two-dimensional (2D) map, the map coordinate system is defined using a pair of latitude and longitude forming 2D coordinates of the 2D map, and the 3D point is located in the map coordinate system using the 2D coordinates.

13. The non-transitory computer readable medium of claim 8, wherein the information includes a drawing rendered from a vectorized map data, and wherein the labeler performs a predetermined image processing algorithm to determine the semantic label of the 3D point.

14. The non-transitory computer readable medium of claim 8, wherein an unlabeled 3D point is provided by the labeler.

15. A method for assigning a semantic label to a three-dimensional (3D) point of a point cloud, comprising steps of:
establishing, using an interface, a communication with an external map server storing a map defined in a map coordinate system;
determining a location on the map corresponding to the 3D point; and
querying the map using the location to obtain an information relevant to a semantic label at the location in the map, wherein the semantic label of the 3D point is determined by using the information.

16. The method of claim 15, wherein the information includes an image, and wherein the labeler performs an image classification of the image to determine the semantic label of the 3D point.

17. The method of claim 15, wherein the information includes an image, wherein the steps further comprise:
rendering the image to a user for performing a semantic labeling of the image, wherein the labeler assigns a label received from the user as the semantic label of the 3D point.

18. The method of claim 15, wherein the map is a 3D map, the map coordinate system is defined using a triplet of latitude, longitude, and altitude forming 3D coordinates of the 3D map, and the 3D point is located in the map coordinate system using the 3D coordinates.

19. The method of claim 15, wherein the map is a two-dimensional (2D) map, the map coordinate system is defined using a pair of latitude and longitude forming 2D coordinates of the 2D map, and the 3D point is located in the map coordinate system using the 2D coordinates.

20. The method of claim 15, wherein the information includes a drawing rendered from a vectorized map data, and wherein the labeler performs a predetermined image processing algorithm to determine the semantic label of the 3D point.
